(19) United States
(12) Patent Application Publication
(10) Pub. No.: US 2009/0103568 A1
(43) Pub. Date: Apr. 23, 2009

(54) Method and System for Non-Gaussian Code-Division-Multiple-Access Signal Transmission and Reception

(75) Inventors: Aminata Amadou GARBA, Montreal (CA); Jan BAJCSY, Baie d'Urfe (CA)

Correspondence Address: FREEDMAN & ASSOCIATES, 117 CENTREPOINTE DRIVE, SUITE 350, NEPEAN, ONTARIO, K2G 5X3, CA

(73) Assignee: McGill University, Montreal (CA)

(21) Appl. No.: 12/254,143

(22) Filed: Oct. 20, 2008

Related U.S. Application Data
(60) Provisional application No. 60/960,914, filed on Oct. 19, 2007.

(51) Int. Cl. H04J 13/00

(52) U.S. Cl. 370/479

(57) ABSTRACT

The present invention relates to a method and system for non-Gaussian code-division-multiple-access signal transmission and reception. Input probability data indicative of a non-equiprobable channel input probability mass function are determined based on received channel data indicative of characteristics of a CDMA transmission channel. The input probability data are determined such that a transmission signal received after transmission has a non-Gaussian distribution. Upon receipt of input user data, a CDMA signal is generated by modulating the received user input data in dependence upon the input probability data and provided for transmission. After transmission a received transmission signal is first processed for determining second channel data and then for determining an estimate indicative of the user input data based on the second channel data.

### FIELD OF THE INVENTION

This invention relates to multi-access transmissions and in particular to a method and system for non-Gaussian code-division-multiple-access signal transmission and reception.

### BACKGROUND OF THE INVENTION

Code-Division-Multiple-Access (CDMA) is a form of multiplexing that does not divide the data transmission of different channels by time—as in TDMA—or frequency—as in FDMA—but instead encodes data with a special code associated with each channel and uses constructive interference properties of the special codes to perform the multiplexing.

Compared to other multiplexing techniques CDMA is highly flexible in asynchronous and decentralized networking, enabling substantially secure and high data rate transmissions. A present day need for high speed, high data rate, and secure communication has substantially increased the employment of CDMA in numerous commercial, government and military applications. In many CDMA transmissions, Single-User Detection/Decoding (SUD) is used. For this type of transmission, it has been taught that the theoretical throughput or spectral efficiency is limited to approximately 0.72 bits per channel use, as disclosed, for example, in S. Verdú and S. Shamai: “Spectral efficiency of CDMA with random spreading”, IEEE Transactions on Information Theory, pp. 622-640, March 1999. Furthermore, in simulated and implemented CDMA systems with SUD, the achieved spectral efficiencies have been very low due to severe multi-user interference which corrupts the transmitted information. This poses a significant obstacle for the development of future networks based on CDMA. Examples of future networks include optical, coaxial, twisted pair of wires, and—beyond 3G—wireless networks, which are expected to integrate multiple services and to support high data rates for various types of data such as multimedia and on-demand video.

In A. A. Garba, R. M. H. Yim, J. Bajcsy, and L. R. Chen: “Analysis of optical CDMA signal transmission: Capacity and simulation results”, EURASIP Journal on Applied Signal Processing—Special Issue on Signal Analysis Tools for Optical Information Processing, pp. 1603-1616, July 2005, it has been taught that a class of severely non-equiprobable channel input Probability Mass Functions (PMFs) theoretically enables achievable CDMA network spectral efficiencies of more than 3 bits per channel use. This corresponds to a 4 times increase compared to the state of the art using equiprobable input PMFs.

It would be highly desirable to overcome the above limitations of the state of the art and to provide CDMA transmission with SUD having a substantially higher spectral efficiency.

### SUMMARY OF THE INVENTION

It is, therefore, an object of embodiments of the invention to provide CDMA transmission with SUD having a substantially higher spectral efficiency.

In accordance with the present invention there is provided a method for non-Gaussian Code-Division-Multiple-Access (CDMA) signal transmission comprising:
providing input probability data indicative of a non-equiprobable channel input probability mass function, the input probability data being such that a transmission signal received after transmission has a non-Gaussian distribution;
receiving user input data;
generating a CDMA signal by modulating the received user input data in dependence upon the input probability data; and,
providing the CDMA signal for transmission.

In accordance with the present invention there is further provided a method for processing a Code-Division-Multiple-Access (CDMA) transmission signal comprising:
a) receiving the transmission signal;
b) processing the transmission signal for determining channel data;
c) processing the transmission signal for determining an estimate indicative of encoded user input data based on the channel data;
d) error-correcting decoding the estimate indicative of the encoded user input data to determine estimated decoded data;
e) processing the transmission signal for determining a second estimate indicative of the encoded user input data based on the channel data and the estimated decoded data;
f) error-correcting decoding the second estimate indicative of the encoded user input data to determine second estimated decoded data; and,
g) repeating c) and f) until a stopping criterion is satisfied.

In accordance with the present invention there is yet further provided a storage medium having stored therein executable commands for execution on at least a processor, the at least a processor when executing the commands performing:
providing input probability data indicative of a non-equiprobable channel input probability mass function, the input probability data being such that a transmission signal received after transmission has a non-Gaussian distribution;
generating a CDMA signal by modulating the received user input data in dependence upon the input probability data; and,
providing the CDMA signal for transmission.

In accordance with the present invention there is yet her provided a storage medium having stored therein executable commands for execution on at least a processor, the at least a processor when executing the commands performing:
a) receiving a Code-Division-Multiple-Access (CDMA) transmission signal;
b) processing the transmission signal for determining channel data;
c) processing the transmission signal for determining an estimate indicative of encoded user input data based on the channel data;
d) error-correcting decoding the estimate indicative of the encoded user input data to determine estimated decoded data;
e) processing the transmission signal for determining a second estimate indicative of the encoded user input data based on the channel data and the estimated decoded data;
f) error-correcting decoding the second estimate indicative of the encoded user input data to determine second estimated decoded data; and,
g) repeating e) and f) until a stopping criterion is satisfied.

In accordance with the present invention there is yet further provided a system for non-Gaussian Code-Division-Multiple-Access (CDMA) signal transmission comprising:
first circuitry, in operation the first circuitry providing input probability data indicative of a non-equiprobable channel input probability mass function, the input probability data being such that a transmission signal received after transmission has a non-Gaussian distribution;
a first input port for receiving user input data;
second circuitry connected to the first input port and the first circuitry, in operation the second circuitry generating a CDMA signal by modulating the received user input data in dependence upon the input probability data; and,
an output port connected to the second circuitry for providing the CDMA signal for transmission.

In accordance with the present invention there is yet further provided a system for processing a Code-Division-Multiple-Access (CDMA) transmission signal comprising:
an input port for receiving the transmission signal;
first circuitry connected to the input port, in operation the first circuitry processing the transmission signal for determining channel data;
second circuitry connected to the input port, the first circuitry and feedback circuitry, in operation the first circuitry processing the transmission signal for determining an estimate indicative of the encoded user input data based on the channel data and estimated decoded data;
third circuitry connected to the second circuitry and the feedback circuitry, in operation the third circuitry error-correcting decoding the estimate indicative of the encoded user input data to determine the estimated decoded data;
control circuitry connected to the second circuitry and the third circuitry, in operation the control circuitry controlling iterative operation of the second circuitry and the third circuitry; and,
an output port connected to the third circuitry for providing the estimated decoded data after termination of the iterative operation.

### BRIEF DESCRIPTION OF THE FIGURES

Exemplary embodiments of the invention will now be described in conjunction with the following drawings, in which:

FIG. 1a is a simplified block diagram illustrating a CDMA modulator according to the invention;

FIG. 1b is a simplified block diagram illustrating a CDMA demodulator according to the invention;

FIG. 1c is a simplified block diagram illustrating an iterative CDMA receiver according to the invention;

FIG. 2a is a simplified block diagram illustrating a chip-level, memory-less channel model for CDMA network transmission with SUD;

FIG. 2b is a simplified diagram illustrating a chip-level channel model for 2-user quaternary (M=4) CDMA network transmission with SUD;

FIG. 3 is a simplified block diagram illustrating a DS-CDMA transmission with SUD at the receiver according to the invention;

FIG. 4 is a simplified block diagram illustrating a soft-decision single-user DS-CDMA demodulator according to the invention;

FIGS. 5a and 5b are diagrams illustrating BER performance for the DS-CDMA transmission according to the invention using quaternary spreading sequences of length N=20 after turbo decoding and after turbo and RS decoding, respectively;

FIG. 6 is a simplified block diagram illustrating a CDMA transmission with SUD based on time/frequency hopping according to the invention;

FIG. 7 illustrates one stage of a trellis diagram of a 16-ary non-recursive TCM encoder of rate 2;

FIG. 8a is a diagram illustrating number of interfering users for different time instances for the time/frequency CDMA transmission shown in FIG. 6;

FIG. 8b is a diagram illustrating non-Gaussian multi-user interference for the CDMA transmission shown in FIG. 6 with K=64 users and P_{ch}=0.0355;

FIG. 8c Gaussian multi-user interference for a state of the art CDMA transmission with equiprobable channel input PMFs for K=64 users; and,

FIGS. 9a and 9b are diagrams illustrating BER performance for the time/frequency hopping CDMA transmission according to the invention with 16-ary modulation, 24.4 dB SNR and channel probability P_{ch}=0.0355 after turbo decoding and after turbo and RS decoding, respectively.

### DETAILED DESCRIPTION OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

For the sake of clarity and to provide a better understanding of the invention, a brief overview of the state of the art of CDMA transmission will be presented in the following.

Considering a CDMA transmission with SUD based on a corresponding chip-level Gaussian multi-access channel with Gaussian Multi-User Interference (MUI) it is possible to use Shannon's—single user—Gaussian channel capacity result. The corresponding network throughput limit is then given as a function of the Signal to Noise Ratio (SNR) for a K-user network by:

$$C = \frac{K}{2} {log}_{2} ( 1 + \frac{S N R}{1 + ( K - 1 ) S N R} ) {}_{K \to ∞} 0.72 per C D M A chip .$$

Various other theoretical approaches have also resulted in limits of the spectral efficiency of CDMA transmission with SUD between 0.69 and 0.72 bits per CDMA chip.

Furthermore, achieved—simulated and experimental—spectral efficiencies of CDMA network transmissions with SUD have been substantially lower than the theoretically determined spectral efficiency limit of 0.72 bits per CDMA chip, for example, approximately 0.05 bits per CDMA chip in un-encoded optical CDMA. This achieved low spectral efficiency is due to severe Gaussian MUI which degrades the transmitted information. Consequently, several families of spreading sequences with enhanced correlation properties have been introduced to reduce the Gaussian MUI. However, while the Bit Error Rate (BER) performance is slightly improved no substantial improvement in the spectral efficiency has been achieved, Furthermore, the use of hardlimiters to improve the BER performance by reducing the Gaussian MUI results in a noticeable reduction of the spectral efficiency. A more efficient method to eliminate the effect of the Gaussian MUI and to improve the BER performance is the use of error correcting codes. However, in some practical situations the matched filter demodulator does not provide sufficiently accurate estimates to the error correcting decoders to recover the sent information.

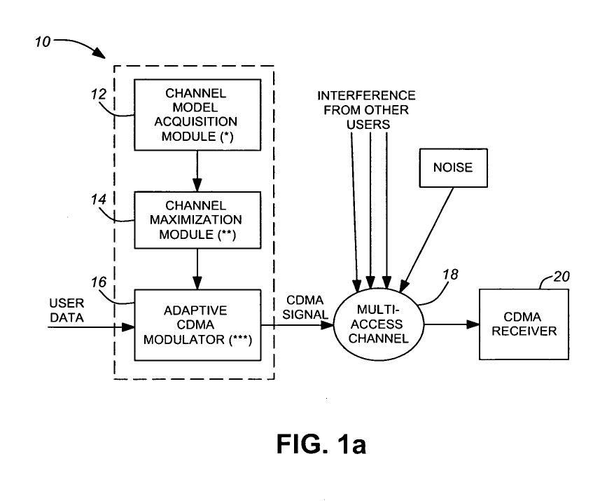

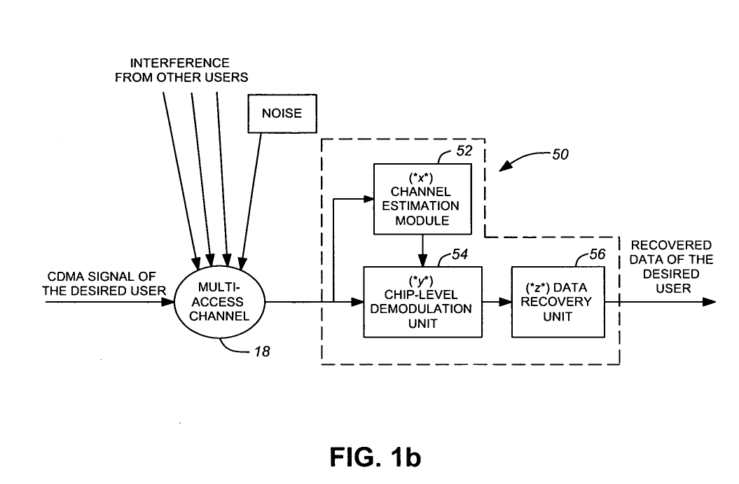

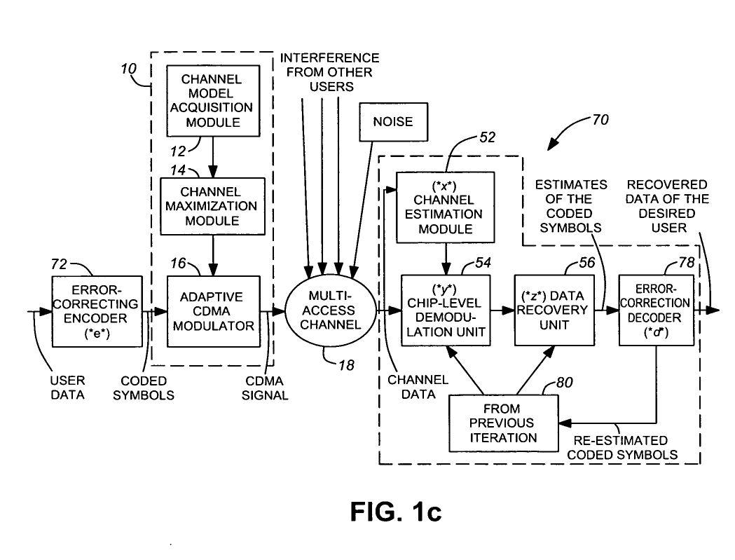

State-of-the-art CDMA transmissions have a Gaussian MUI leading to a substantially Gaussian distribution of the interference signal at the receiver. The Gaussian distribution of the interference signal is caused by a substantially Gaussian distribution of the transmitted signals from different users. Furthermore, due to the Central Limit Theorem, even multiple CDMA signals having a non-Gaussian distribution lead in many cases to a substantially Gaussian distribution of the interference signal. Referring to FIG. 1a, a CDMA modulator 10 according to the invention is shown. The CDMA modulator 10 generates CDMA transmission signals leading to a non-Gaussian MUI on the transmission channel by utilizing an optimized distribution of binary or non-binary CDMA chip symbols. This distribution—a non-equiprobable channel input PMF—is determined based on characteristics of the transmission channel used such as, for example: optical, wireless, or wireline channel; usage of single or multiple wavelengths, antennas, or cables; number of active users on the transmission channel; and collaboration or independence of the users. Channel model acquisition module 12 receives data indicative of characteristics of the transmission channel such as, for example, number of active users, signal-to-noise-ratio, number of antennas and determines parameters of a corresponding information—theoretic communication channel model. Channel maximization module 14, connected to the channel model acquisition module 12, uses the parameters to determine data indicative of an optimized non-equiprobable channel input PMF that substantially maximizes the information transmitted. This maximization is performed, for example, using an optimization process for determining maxima of real-valued functions. Finally, adaptive CDMA modulator module 16, connected to the channel maximization module 14 uses the data indicative of an optimized non-equiprobable channel input PMF provided by the channel maximization module 14 to adjust the frequency of usage of the different CDMA symbols—for example, 0, 1, 2—when modulating received user data to generate the CDMA transmission signal. The CDMA transmission signal is then transmitted via multi-access channel 18 and received at CDMA receiver 20. Due to non-Gaussian MUI the received interference signal has a non-Gaussian distribution, for example, a Poisson-like distribution.

The processing of modules 12 and 14 is performed at the beginning of a user data transmission and, for example, in predetermined time intervals during transmission or at time instances when the number of users of the transmission line changes. Optionally, the optimized non-equiprobable channel input PMFs are provided, for example, from a look-up table.

The CDMA modulator 10 is, for example, implemented in a hardware fashion, for example, using a semiconductor chip or Field-Programmable Gate Array (FPGA), or by executing, on a processor, executable commands stored in a storage medium.

The CDMA modulator 10 is applicable in various CDMA modulations such as, for example, direct-sequence CDMA, frequency-hopping CDMA, time-hopping CDMA, and CDMA based on trellis-coded modulation.

The ability of the CDMA modulator 10 to control bow frequently different chip symbols are used to represent user data in the CDMA transmission signal enables the generation of a predetermined non-Gaussian MUI which results in an improved system performance such as, for example, bandwidth or spectral efficiency, bit-error rate, number of users supported in a CDMA network.

Referring to FIG. 1b, a CDMA demodulator 50 according to the invention is shown. The CDMA demodulator recovers the user data received at the adaptive CDMA modulator module 16 from the transmitted CDMA signal. The CDMA demodulator 50 comprises three modules, a channel estimation module 52, a chip-level demodulation unit 54, and a data recovery unit 56. The channel estimation module 52 determines channel parameters relevant for the CDMA demodulation process such as, for example, amplitude and phase of fading affecting the signal for demodulation, signal-to-noise ratio of the transmission channel, and number of active users of the CDMA network. The chip-level demodulator unit 54 receives the CDMA transmission channel signal and the channel parameters determined in the channel estimation module 52 and determines an estimate for each CDMA chip sent by the user. Output data of the chip-level demodulator unit 54 are, for example, in the form of an array of estimated chip symbols and a corresponding array of reliability factors for each chip symbol estimate, or in the form of an array of a-posteriori probability estimates for each chip symbol taking different values. The data recovery unit 56 then transforms the reliability estimates for the chip symbols into estimates for transmitted data symbols of the user and determines the bit/symbol of the user data received at the adaptive CDMA modulator module 16 based on the estimates for transmitted data symbols of the user.

The CDMA demodulator 50 is, for example, implemented in a hardware fashion, for example, using a semiconductor chip or FPGA, or by executing, on a processor, executable commands stored in a storage medium.

The CDMA demodulator 50 is applicable in various CDMA modulations such as, for example, direct-sequence CDMA, frequency-hopping CDMA, time-hopping CDMA, and CDMA based on trellis-coded modulation. Furthermore, the CDMA demodulator 50 is also applicable for Gaussian CDMA signal transmission, i.e. is backward compatible.

Error-correcting codes are frequently used in digital communication systems such as, for example, GSM cellular phones and 3G wireless systems. Error-correcting codes substantially improve overall hit-error-rate performance, bandwidth utilization and power efficiency of the communication system. Used error-correcting codes are, for example, convolutional, turbo, algebraic, or concatenated codes, depending on the communication system.

If an error correcting code is used, a user's data symbols are encoded using an error-correcting encoder before being provided to the adaptive CDMA modulator module 16. The output data provided by the data recovery unit 56 are then passed through a corresponding error-correcting decoder to recover the user data.

Referring to FIG. 1c, an iterative receiver 70 according to the invention is shown. User data are encoded using error-correcting encoder 72 and modulated using CDMA modulator 10. During a first iteration, the channel estimation module 52, the chip-level demodulation unit 54 and the data recovery unit 56 proceed as described above. The data recovery unit 56 generates estimates of the encoded symbols, i.e. estimates of input symbols received at the adaptive CDMA modulator module 16. The estimates are then provided to error-correcting decoder 78 which uses them together with constraints of the error-correcting code to estimate the coded data. The estimated coded data are then fed back into the chip-level demodulation unit 54 and the data recovery unit 56 for a following iteration step. During the second iteration step—and during following iteration steps—the chip-level demodulation unit 54 and the data recovery unit 56 update their estimates using the received transmission channel data as well as the estimated coded symbols from the previous iteration step. The updated estimates are then provided to the error-correcting decoder 78, which uses them to update its estimates of the user's data and its re-estimates of the coded symbols. The re-estimated coded symbols are then fed back to the chip-level demodulation unit 54 and the data recovery unit 56 for the next iteration step.

The iteration is performed for a predetermined number of iteration steps or when the recovered data have reached a predetermined level of reliability. After the final iteration the recovered user data are provided for further processing such as, for example, display or storage.

The iterative receiver 70 is applicable for use with different formats for the estimated symbols.

The iterative receiver 70 is, for example, implemented in a hardware fashion, for example, using a semiconductor chip or FPGA, or by executing, on a processor, executable commands stored in a storage medium.

Furthermore, the iterative receiver 70 is also applicable for Gaussian CDMA signal transmission, i.e. is backward compatible.

The CDMA transmission according to the invention is based on non-equiprobable, intensity-based CDMA signaling, i.e. the channel input PMFs optimizing the mutual information between the input signal and the output signal of the CDMA transmission are substantially non-equiprobable. As opposed to the equiprobable or Gaussian signaling of the state of the art CDMA transmission, the use of symbols with optimized, non-equiprobable input PMF results in a distinct non-Gaussian MUI that is substantially reduced. The non-Gaussian MUI enables the demodulator according to the invention to provide reliable estimates of the transmitted information. An intensity-based signal constellation allows the use of optimized channel input PMF with good power efficiency.

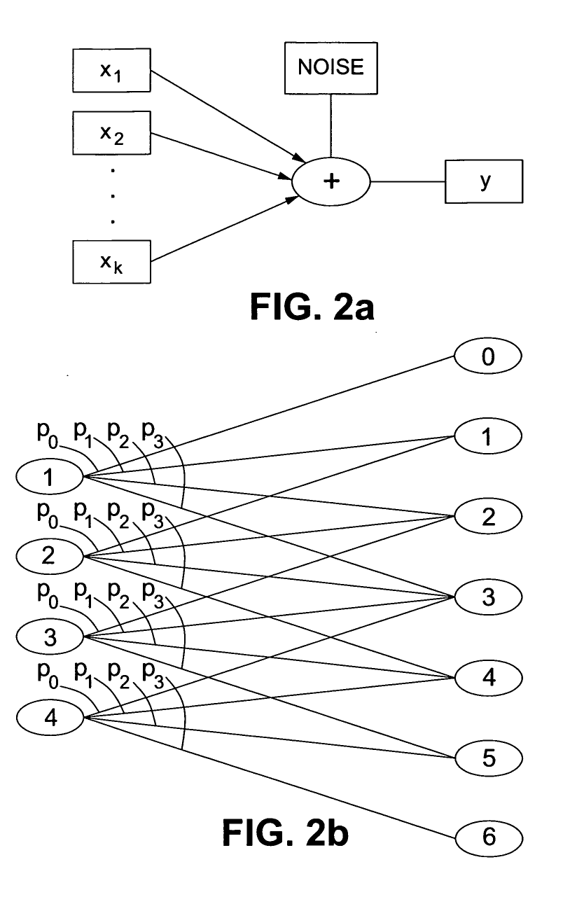

Considering a bit-asynchronous CDMA network transmission with K active users sending information through the transmission channel simultaneously and independently—i.e. without cooperation. At the transmitter side, independent users' sources generate information bits having values 0 or 1 with a probability of 0.5. These information bits are, for example, first encoded using an Error Correcting Code (ECC) and then modulated prior to being sent through the transmission channel. The receiver performs SUD to recover the sent information. In case of chip-synchronous transmission—i.e. the worst case scenario for CDMA interference—the transmission channel, as shown in FIG. 2a, is modeled at the chip level by appropriate discrete or continuous-time memory-less channels which output signal is given by:

Y=X₁+X₂+ . . . +X_{K}+Z. (1)

In the absence of noise (Z=0), the entries of the resulting transmission channel matrix P_{Y|X}_{₁} are the conditional probabilities of an output symbol, given a respective input symbol, described for all y ∈{0, 1, 2, . . . , K(M−1)} and x₁ ε{0, 1, 2, . . . , M−1} as:

$${P}_{Y \vert {X}_{1}} ( Y = y \vert {X}_{1} = {x}_{1} ) = {\sum }_{{( {x}_{2} , {x}_{3} , … , {x}_{K} ) ∈ {\{ 0 , 1 , 2 , … , M - 1 \}}^{K - 1}}_{{s . t .}_{{x}_{2} + {x}_{3} + … + {x}_{K} = ( y - {x}_{1} )}}} {P}_{{x}_{2}} {P}_{{x}_{3} } … {P}_{{x}_{K}} . \qquad ( 2 )$$

Considering as an example, the case of a 2-user quaternary (M=4) CDMA network transmission in the absence of noise (Z=0). At the chip level, each user's source sends chip symbols 0, 1, 2, or 3 with probabilities p₀, p₁, p₂, p₃=(1−p₀−p₁−p₂). It is possible to model such a transmission as a discrete memory-less channel, as shown in FIG. 2b, with a transmission matrix as follows:

$${P}_{Y \vert {X}_{1}} = ( \begin{matrix}{p}_{0} & {p}_{1} & {p}_{2} & {p}_{3} & 0 & 0 & 0 \\ 0 & {p}_{0} & {p}_{1} & {p}_{2} & {p}_{3} & 0 & 0 \\ 0 & 0 & {p}_{0} & {p}_{1} & {p}_{2} & {p}_{3} & 0 \\ 0 & 0 & 0 & {p}_{0} & {p}_{1} & {p}_{2} & {p}_{3}\end{matrix} ) .$$

If chip symbol 0 is sent by user 1, the output chip has values y=0, 1, 2, 3, if and only if the interfering user sends chip symbol x₂=0, 1, 2, 3. Hence, the entries of the first row of the transmission matrix are pₘ for y=0, 1, 2, 3 and zero for y=4,5,6. The noiseless channel output signal Y is the sum of the symbol intensities sent by the two active users' sources and has values 0, 1, 2, 3, 4, 5, and 6 with probabilities p₀², 2p₀p₁, p₁²+2p₀p₂, 2p₁p₂+2p₃p₀, p₂²+2p₁p₃, 2p₂p₃, and p₃², respectively. The theoretical spectral efficiency—aggregate throughput for the two independent users—is limited to approximately 1.7 bits per CDMA chip, due to maximal mutual information I(X_{—}1;Y) on the channel, and is achieved with non-equiprobable channel input PMFs p₀=0.3834, p₁=0, p₂=0.3713, and p₃=0.2454.

The transmission channel matrix P_{Y|X}_{₁} depends on the channel input PMF. Consequently, the transmission channel model representing the CDMA transmission is not a constant—fixed—channel as taught in the state of the art. This property of the transmission channel results in a reduced MUI which is non-Gaussian and in substantially non-equiprobable channel input PMFs.

In the presence of noise, the input probability distribution is determined using the noise distribution. For example, if the information is corrupted by an independent zero mean Additive White Gaussian Noise (AWGN) sample Z with variance σ², the channel conditional probability density function is given by:

$${f}_{Y \vert {X}_{1}} ( y \vert {x}_{1} ) = \frac{1}{\sqrt{2 π} σ} {\sum }_{{x}_{2} = 0}^{M - 1} {\sum }_{{x}_{3} = 0}^{M - 1} … {\sum }_{{x}_{k} = 0}^{M - 1} ( {e}^{\frac{- 1}{2 {σ}^{2}} {( y - {\sum }_{i = 1}^{K} {x}_{i} )}^{2}} {\prod }_{i = 2}^{K} P ( {X}_{i} = {x}_{i} ) ) . \qquad ( 3 )$$

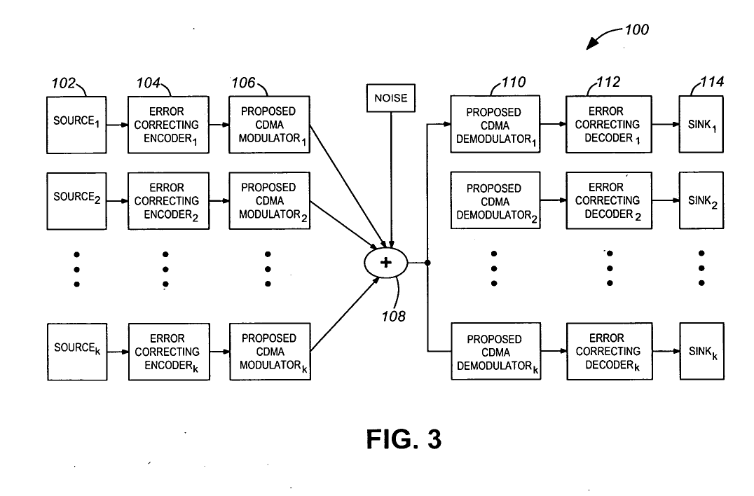

Referring to FIG. 3, a schematic block diagram of a Direct Sequence (DS)—CDMA transmission system 100 according to the invention is shown. Information symbols sent from K users' sources 102 for transmission to one of K receiving sinks 114 are processed as follows. Using ECC encoders 104 the information bits sent from the K users' sources 102 are encoded and then provided to CDMA modulators 106 according to the invention. The CDMA modulators 106 are, for example, implemented based on the modulator 10 disclosed above. The CDMA modulator 106 maps the individual users's encoded information bits into a spreading code, i.e. bit value ‘0’ is mapped into spreading sequence [symbol] and bit value ‘1’ is mapped into a different spreading sequence [symbol] as follows:

$${b}_{i} = 0 {}^{spread \text{-} data} = ( {c}_{i}^{0} ( 1 ) , {c}_{i}^{0} ( 2 ) , … , {c}_{i}^{0} ( N ) )$$

$${b}_{i} = 1 {}^{spread \text{-} data} = ( {c}_{i}^{1} ( 1 ) , {c}_{i}^{1} ( 2 ) , … , {c}_{i}^{1} ( N ) ) .$$

The spreading sequences of length N comprise channel input symbols—chip symbols—with real values 0, 1, 2, . . . , M−1, which are used according to an optimized channel input PMF, determined as disclosed above. The near-optimal channel input PMF depends on both, the modulation level and the number of users, and is substantially non-equiprobable where the channel input symbols 0, 1, 2, . . . , M−1 are used with low probabilities—usually slightly different from each other, and the channel input symbol 0 is the most likely used symbol:

$${p}_{0} \approx 1 - \frac{( 1 \pm ɛ )}{K} \\ {p}_{1} \approx {p}_{2} \approx … \approx {p}_{M - 1} \approx \frac{( 1 \pm ɛ )}{K ( M - 1 )} \qquad ( 4 )$$

where ε≈10% is the tolerance within which the channel input PMF achieves near-capacity spectral efficiencies.

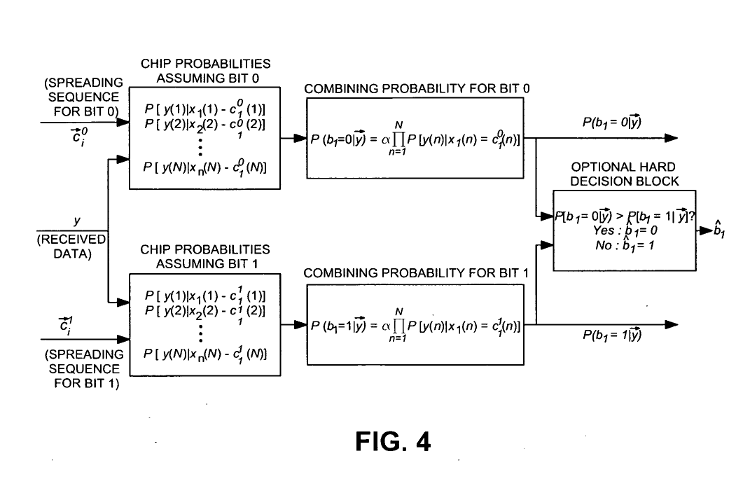

After transmission through transmission channel 108 received transmission channel data [symbol] =(y(1), y(2), . . . , y(N)) are processed using soft-decision CDMA de-modulator 110 according to the invention. The CDMA de-modulator 110 is, for example, implemented based on the de-modulator 50 disclosed above. The soft-decision CDMA de-modulator 110 shown in FIG. 4, operates separately for each user, i.e. performs SUD and treats the CDMA transmission as a repetition-like code on the multi-access transmission channel 108. It operates chip-by-chip using the transmission channel model and the spreading sequences corresponding to a predetermined first user in order to determine posterior probabilities for the received information as follows:

$$P ( {b}_{1} = 0 \vert ) = α {\prod }_{n = 1}^{N} P [ y ( n ) \vert {x}_{1} ( n ) = {c}_{1}^{0} ( n ) ] \\ P ( {b}_{1} = 1 \vert ) = α {\prod }_{n = 1}^{N} P [ y ( n ) \vert {x}_{1} ( n ) = {c}_{1}^{1} ( n ) ] . \qquad ( 5 )$$

The above probabilities in equation (5) are determined using the transmission channel data [symbol] =(y(1), y(2), . . . , y(N)), the spreading sequences corresponding to a predetermined first user— [symbol] and [symbol] —and the transmission channel model, i.e. equations (2) and (3) in the case of noiseless and AWGN, respectively. Optionally, the CDMA de-modulator 110 according to the invention generates a hard decision about a symbol received from the first user by comparing the estimated posterior probabilities, i.e.

$${\hat{b}}_{1} = \{ \begin{matrix}0 & P [ {b}_{1} = 0 \vert ] > P [ {b}_{1} = 1 \vert ] \\ 1 & otherwise .\end{matrix} \qquad ( 6 )$$

The CDMA de-modulator 110 operates in a similar fashion to de-modulate the other encoded information bits received from user 1 in a similar fashion, as well as to de-modulate the encoded information bits received from other users. After the de-modulation the encoded information bits are processed in ECC decoders 112 and decoded information bits are then provided to the respective recipient—sink 114.

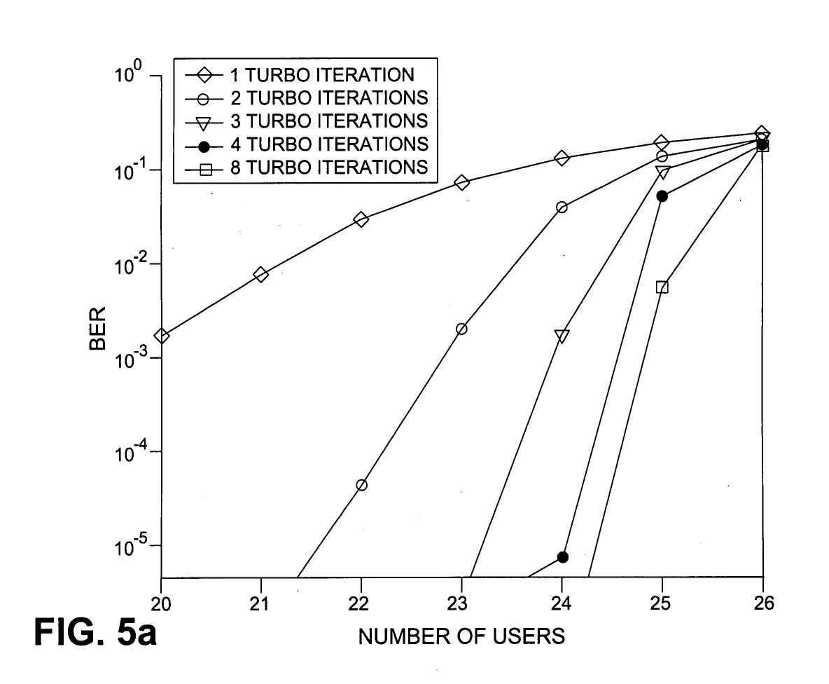

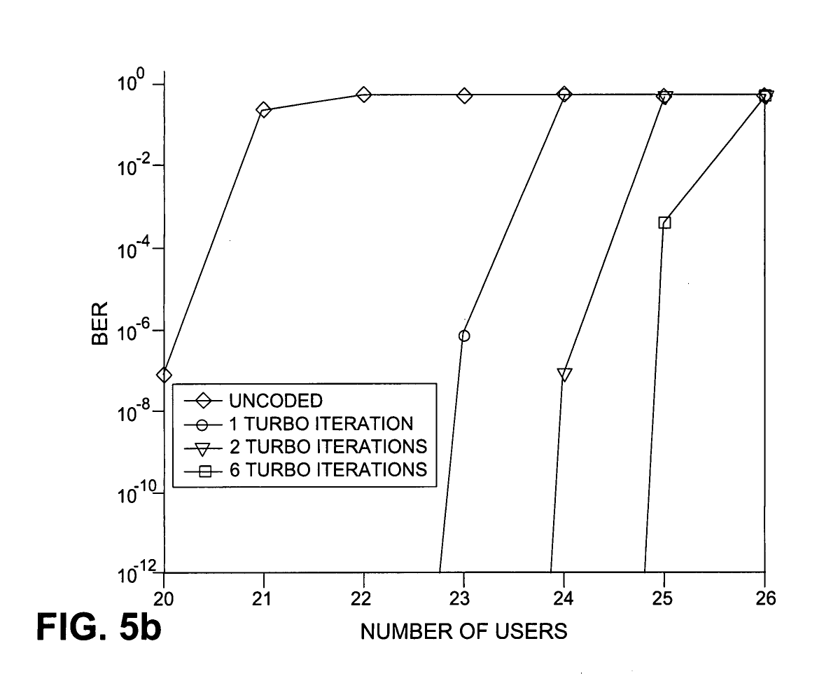

The system 100 has been simulated with non-equiprobable quaternary (M=4) spreading sequences of length N=20. The ECC encoder comprises a concatenation of Berrou's rate ⅓ turbo code encoder using random interleavers of size 5000, and (255, 239) Read-Solomon (RS) code over GF (256) encoder. The two encoders are separated by random interleavers of size 15000. The spreading sequences are generated with channel input PMF p₀=0.9, p₁=0, and p₂=p₃=0.05 where the bit value ‘0’ is mapped in a all zero spreading sequence, i.e. [symbol] =0,0, . . . , 0 and the bit value ‘1’ is mapped into a non-zero sequence [symbol] FIGS. 5a and 5b illustrate the BER performance after turbo decoding, and after turbo and RS decoding, respectively. The BER performances illustrated in FIGS. 5a and 5b demonstrate the high performance of the system 100, even in the case of overloading—number of users higher than the length of the spreading sequence—and the achieved spectral efficiency is over 0.42 bits per CDMA chip.

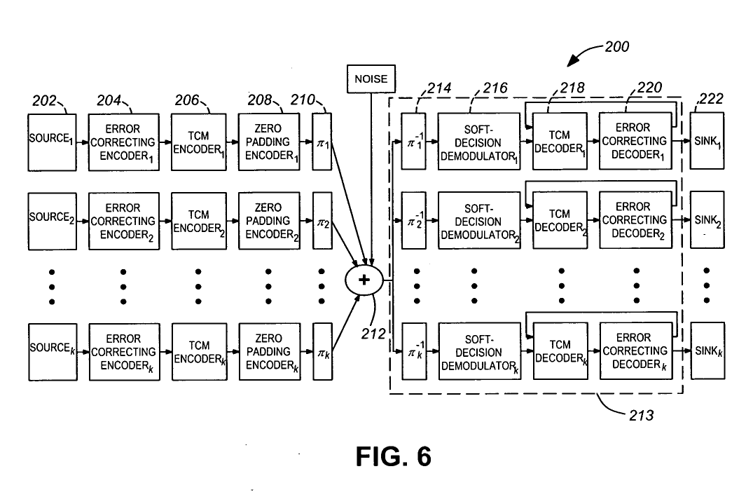

Referring to FIG. 6, a schematic block diagram of a CDMA transmission system 200 according to the invention is shown. Information symbols sent from K users' sources 202 are transmitted through transmission channel 212 to one of K receiving sinks 222 as follows. The CDMA transmission system 200 is based on a combination of time/frequency hopping, ECC encoding, and Trellis-Coded Modulation (TCM). Here, ECC encoded information symbols sent from a user's source 202 and processed using ECC encoder 204 are transmitted through the transmission channel 212 using time/frequency slots as frequently as determined based on the near-optimal channel input PMF. The probability of using the transmission channel 212 for each user—P_{ch}—is determined such that the near-optimal PMF given in equation (4) is satisfied, i.e.

$${P}_{ch} \approx M \times {p}_{1} \approx \frac{M \pm M ɛ}{MK - K} . \qquad ( 7 )$$

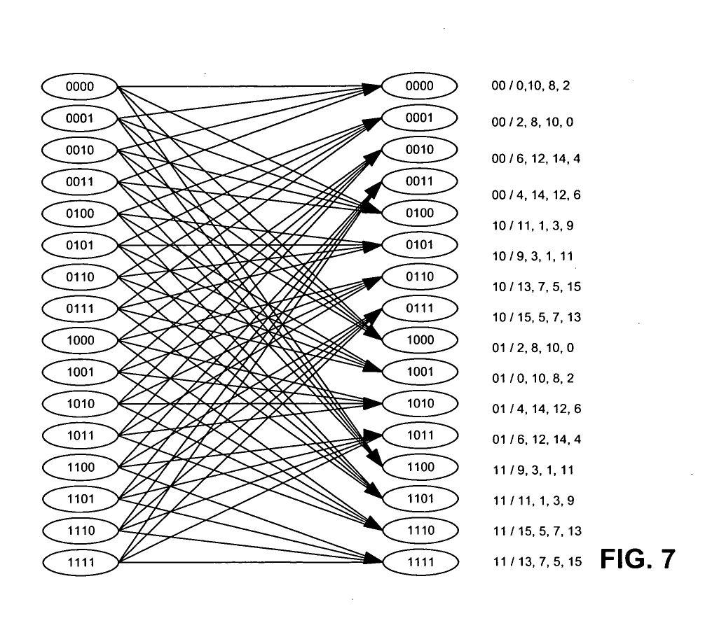

Therefore, each transmitted symbol is corrupted by only few symbols from interfering users and the achieved spectral efficiency significantly exceeds the Gaussian capacity limit of 0.72 bits per CDMA chip. In case of binary CDMA transmission ECC encoded information bits are directly transmitted through the transmission channel 212. In case of M-ary CDMA transmission (M>2) are modulated using TCM encoder 206. FIG. 7 illustrates one stage of a trellis diagram of a 16-ary non-recursive TCM encoder of rate 2. The edges show the transition from a previous state at time instant t-1 to a current state at time t. Each line at the left of the current state indicates 2 bits binary input symbols and corresponding 16-ary modulated output symbols for each transition ending at that state. The output symbols of the TCM encoder 206 are permuted and then processed in Zero-Padding encoder 208, which performs the function of a time/frequency selector. The use of the TCM encoder 206 enables symbol modulation into higher modulation levels for non-binary transmission and into different binary symbols for binary transmission. The TCM encoder 206 is implemented in a feed-forward fashion or, alternatively, in a recursive fashion. The Zero-Padding encoder 208 is used to match the determined near-optimal channel input PMF by adding extra zeros to the encoded and modulated information symbols. In operation, the Zero-Padding encoder 208 allocates time/frequency slots to each user such that the near-optimal channel input PMF is achieved. Finally, the encoded and modulated information symbols are permuted again using user specific channel interleavers 210 prior to being sent through the transmission channel 212 where multi-user interference and additional noise corrupt the transmitted information.

Receiver 213 comprises de-interleaver 214, soft-decision demodulator 216 and an iterative ECC decoder. The iterative ECC decoder comprises two decoders—TCM decoder 218 and turbo decoder 220, which are serially and iteratively connected and use a-posterior information to improve overall performance. The number of users transmitting at each time instant Kₜ—used by the soft-decision demodulator 216 is determined, for example, in optical CDMA using a dedicated wavelength and in wireless CDMA by a base station.

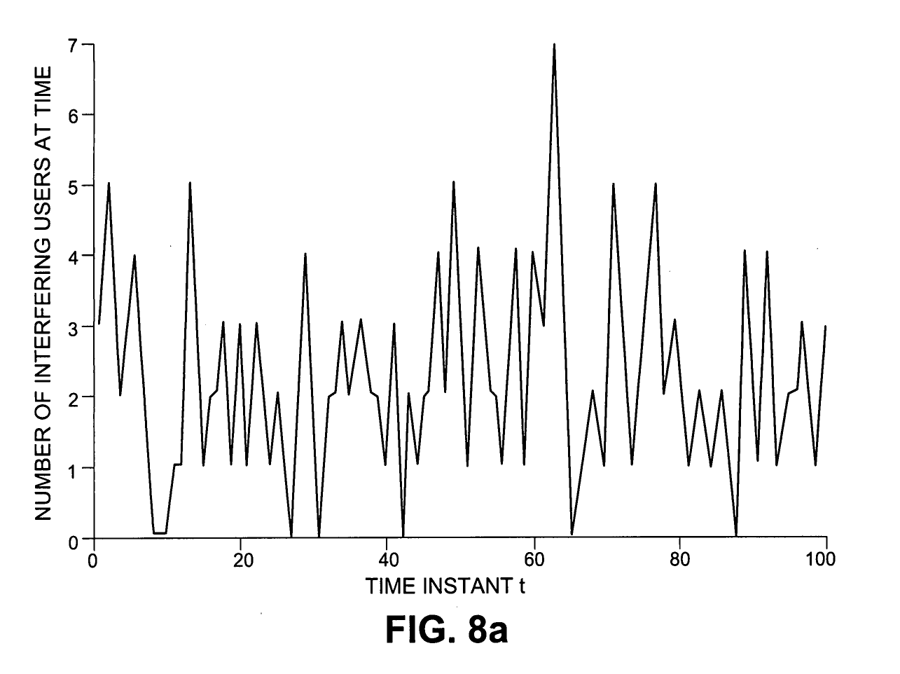

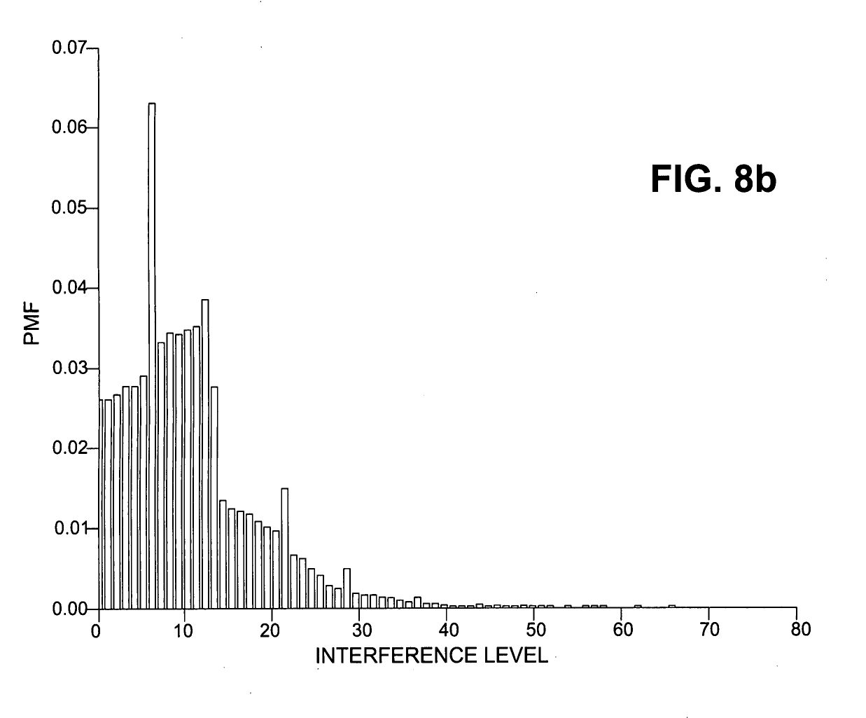

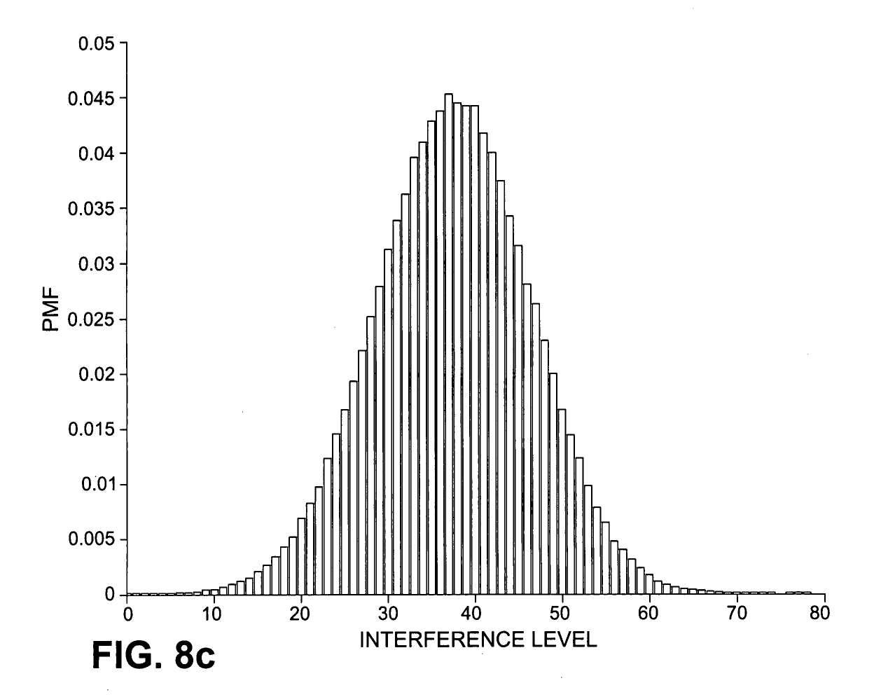

FIG. 8a illustrates the number of interfering users Kₜ for different time instances t for the CDMA transmission system 200, with the total number of active system users is K=376 and channel use probability is P_{ch}=0.006. FIG. 8b illustrates non-Gaussian MUI for the CDMA transmission system 200—K=64 and P_{ch}=0.0355. For comparison, FIG. 8c illustrates Gaussian MUI for equiprobable channel input PMF with K=64 users.

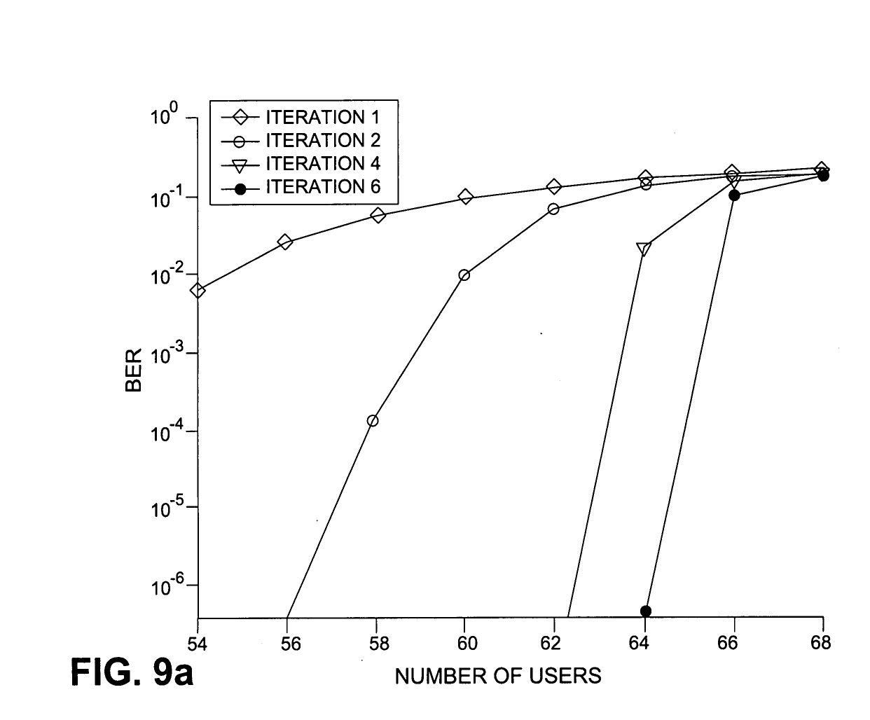

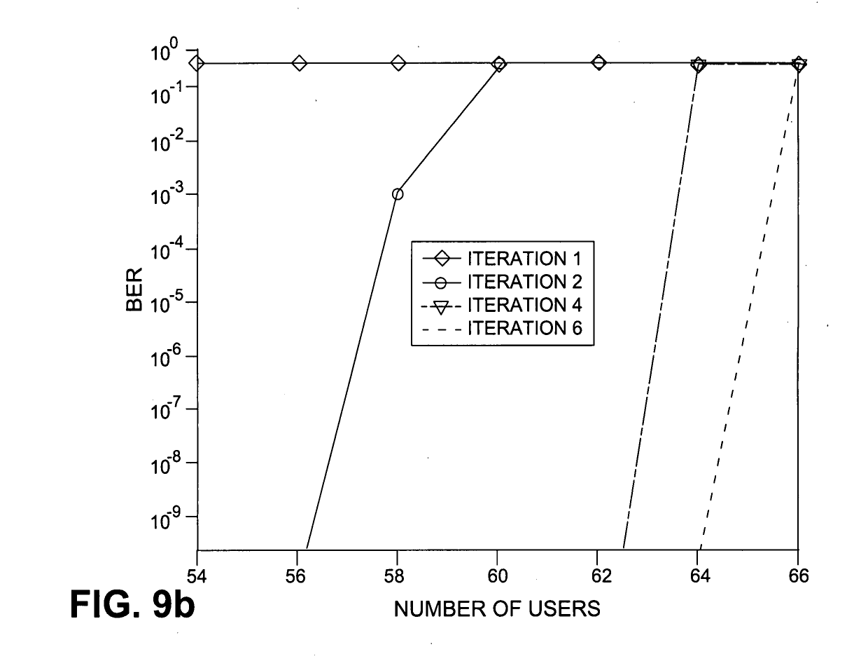

The system 200 has been simulated with 16-ary (M=16) modulation levels at 24.4 dB SNR. S-random interleavers of size 20000 with s=70 has been used. Each user accesses the transmission channel pseudo-randomly at allocated time/frequency slots with channel probability P_{ch}=0.035. FIGS. 9a and 9b illustrate the BER performance after turbo decoding, and after turbo and RS decoding, respectively. The BER performance illustrated in FIGS. 9a and 9b indicate an achieved spectral efficiency of 1.136 bits per CDMA chip, substantially exceeding the theoretical limit of 0.72 bits per CDMA chip for equiprobable channel input PMF.

Numerous other embodiments of the invention will be apparent to persons skilled in the art without departing from the spirit and scope of the invention as defined in the appended claims.

What is claimed is:

1. A method for non-Gaussian Code-Division-Multiple-Access (CDMA) signal transmission comprising:
providing input probability data indicative of a non-equiprobable channel input probability mass function, the input probability data being such that a transmission signal received after transmission has a non-Gaussian distribution;
receiving user input data;
generating a CDMA signal by modulating the received user input data in dependence upon the input probability data; and,
providing the CDMA signal for transmission.

2. A method for non-Gaussian Code-Division-Multiple-Access (CDMA) signal transmission as defined in claim 1 comprising:
receiving channel data indicative of characteristics of a CDMA transmission channel; and,
determining the input probability data based on the received channel data.

3. A method for non-Gaussian Code-Division-Multiple-Access (CDMA) signal transmission as defined in claim 1 comprising:
receiving the transmission signal;
processing the transmission signal for determining second channel data; and,
processing the transmission signal for determining an estimate indicative of the user input data based on the second channel data.

4. A method for non-Gaussian Code-Division-Multiple-Access (CDMA) signal transmission as defined in claim 1 comprising:
a) error-correcting encoding the received user input data;
b) receiving the transmission signal;
c) processing the transmission signal for determining second channel data;
d) processing the transmission signal for determining an estimate indicative of the encoded user input data based on the second channel data;
e) error-correcting decoding the estimate indicative of the encoded user input data to determine estimated decoded data;
f) processing the transmission signal for determining a second estimate indicative of the encoded user input data based on the second channel data and the estimated decoded data;
g) error-correcting decoding the second estimate indicative of the encoded user input data to determine second estimated decoded data; and,
h) repeating f) and g) until a stopping criterion is satisfied.

5. A method for non-Gaussian Code-Division-Multiple-Access (CDMA) signal transmission as defined in claim 1 wherein the CDMA signal is provided for transmission via an optical CDMA transmission channel.

6. A method for non-Gaussian Code-Division-Multiple-Access (CDMA) signal transmission as defined in claim 1 wherein the CDMA signal is provided for transmission via a wireless CDMA transmission channel.

7. A method for non-Gaussian Code-Division-Multiple-Access (CDMA) signal transmission as defined in claim 1 wherein the CDMA signal is provided for transmission via a wireline CDMA transmission channel.

8. A method for processing a Code-Division-Multiple-Access (CDMA) transmission signal comprising:
a) receiving the transmission signal;
b) processing the transmission signal for determining channel data;
c) processing the transmission signal for determining an estimate indicative of encoded user input data based on the channel data;
d) error-correcting decoding the estimate indicative of the encoded user input data to determine estimated decoded data;
e) processing the transmission signal for determining a second estimate indicative of the encoded user input data based on the channel data and the estimated decoded data;
f) error-correcting decoding the second estimate indicative of the encoded user input data to determine second estimated decoded data; and,
g) repeating e) and f) until a stopping criterion is satisfied.

9. A method for processing a Code-Division-Multiple-Access (CDMA) transmission signal as defined in claim 8 wherein the transmission signal is received as a signal having a non-Gaussian distribution.

10. A method for processing a Code-Division-Multiple-Access (CDMA) transmission signal as defined in claim 8 wherein the transmission signal is received as a signal having a Gaussian distribution.

11. A method for processing a Code-Division-Multiple-Access (CDMA) transmission signal as defined in claim 8 wherein the CDMA signal is received from an optical CDMA transmission channel.

12. A method for processing a Code-Division-Multiple-Access (CDMA) transmission signal as defined in claim 8 wherein the CDMA signal is received from a wireless CDMA transmission channel.

13. A method for processing a Code-Division-Multiple-Access (CDMA) transmission signal as defined in claim 8 wherein the CDMA signal is received from a wireline CDMA transmission channel.

14. A system for processing a Code-Division-Multiple-Access (CDMA) transmission signal comprising:
an input port for receiving the transmission signal;
first circuitry connected to the input port, in operation the first circuitry processing the transmission signal for determining channel data;
second circuitry connected to the input port, the first circuitry and feedback circuitry, in operation the first circuitry processing the transmission signal for determining an estimate indicative of the encoded user input data based on the channel data and estimated decoded data;
third circuitry connected to the second circuitry and the feedback circuitry, in operation the third circuitry error-correcting decoding the estimate indicative of the encoded user input data to determine the estimated decoded data;
control circuitry connected to the second circuitry and the third circuitry, in operation the control circuitry controlling iterative operation of the second circuitry and the third circuitry; and,
an output port connected to the third circuitry for providing the estimated decoded data after termination of the iterative operation.

15. A method for Code-Division-Multiple-Access (CDMA) signal transmission comprising: providing input probability data indicative of a non-equiprobable channel input probability mass function;
receiving user input data;
generating a CDMA signal by modulating the received user input data in dependence upon the input probability data; and,
providing the CDMA signal for transmission.

16. A method for Code-Division-Multiple-Access (CDMA) signal transmission as defined in claim 15 comprising:
receiving channel data indicative of characteristics of a CDMA transmission channel; and,
determining the input probability data based on the received channel data.

17. A method for Code-Division-Multiple-Access (CDMA) signal transmission as defined in claim 15 comprising:
receiving the transmission signal;
processing the transmission signal for determining second channel data; and,
processing the transmission signal for determining an estimate indicative of the user input data based on the second channel data.

18. A method for Code-Division-Multiple-Access (CDMA) signal transmission as defined in claim 15 comprising:
a) error-correcting encoding the received user input data;
b) receiving the transmission signal;
c) processing the transmission signal for determining second channel data;
d) processing the transmission signal for determining an estimate indicative of the encoded user input data based on the second channel data;
e) error-correcting decoding the estimate indicative of the encoded user input data to determine estimated decoded data;
f) processing the transmission signal for determining a second estimate indicative of the encoded user input data based on the second channel data and the estimated decoded data;
g) error-correcting decoding the second estimate indicative of the encoded user input data to determine second estimated decoded data; and,
h) repeating f) and g) until a stopping criterion is satisfied.

19. A method for Code-Division-Multiple-Access (CDMA) signal transmission as defined in claim 15 wherein the CDMA signal is provided for transmission via an optical CDMA transmission channel.

20. A method for Code-Division-Multiple-Access (CDMA) signal transmission as defined in claim 15 wherein the CDMA signal is provided for transmission via a wireless CDMA transmission channel.

21. A method for Code-Division-Multiple-Access (CDMA) signal transmission as defined in claim 15 wherein the CDMA signal is provided for transmission via a wireline CDMA transmission channel.
